(19) United States
(12) Patent Application Publication
(10) Pub. No.: US 2024/0308479 A1
(43) Pub. Date: Sep. 19, 2024

(54) Tire Inflation Assembly

(71) Applicant: John Anderson, El Mirage, AZ (US)

(72) Inventor: John Anderson, El Mirage, AZ (US)

(21) Appl. No.: 18/123,293

(22) Filed: Mar. 19, 2023

(51) Int. Cl. B60S 5/04; G01L 17/00

(52) U.S. Cl. CPC B60S 5/04; G01L 17/00

(57) ABSTRACT

A tire inflation assembly includes an air chuck that has a pair of outlets that has a direction of air flow which is oriented at a unique direction with respect to each other. In this way the air chuck can be attached to the valve stem at a variety of orientations to enhance employing the air chuck to inflate the tire. The air chuck includes a locking mechanism which engages the valve stem for retaining the air chuck on the valve stem. The locking mechanism is urgeable to disengage the valve stem to remove the air chuck from the valve stem. A pressure gauge is integrated into the air chuck to display the air pressure in the tire when either of the outlets is attached to the valve stem.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to inflation devices and more particularly pertains to a new inflation device for attaching an air chuck to a valve stem. The device includes an air chuck that has a pair of outlets oriented at an angle with each other to engage a valve stem of a tire. The device includes a locking mechanism that is integrated into the air chuck. The locking member engages the valve stem to retain the air chuck on the valve stems while the tire is being inflated. The locking member is urgeable to disengage the valve stem to remove the air chuck from the valve stem.

### (2) Description of Related Art Including Information Disclosed Under 37 CFR 1.97 and 1.98

The prior art relates to inflation devices including an air blow gun that has a tire inflation chuck. The prior art discloses a tire inflation tool that includes an air chuck, a grapple for engaging a rim of a tire and a spring attached between the air chuck and the grapple. The prior art discloses an air chuck with a variable angle swivel head. The prior art discloses an ornamental design for an air chuck that includes a pair of outlets oriented at an angle with each other.

### BRIEF SUMMARY OF THE INVENTION

An embodiment of the disclosure meets the needs presented above by generally comprising an air chuck that has a pair of outlets that has a direction of air flow which is oriented at a unique direction with respect to each other. In this way the air chuck can be attached to the valve stem at a variety of orientations to enhance employing the air chuck to inflate the tire. The air chuck includes a locking mechanism which engages the valve stem for retaining the air chuck on the valve stem. The locking mechanism is urgeable to disengage the valve stem to remove the air chuck from the valve stem. A pressure gauge is integrated into the air chuck to display the air pressure in the tire when either of the outlets is attached to the valve stem.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tire inflation assembly according to an embodiment of the disclosure.

FIG. 2 is a front perspective view of an embodiment of the disclosure.

FIG. 3 is a bottom view of an embodiment of the disclosure.

FIG. 4 is a right side view of an embodiment of the disclosure.

FIG. 5 is a top view of an embodiment of the disclosure.

FIG. 6 is a cross sectional view taken along line 6-6 of FIG. 5 of an embodiment of the disclosure showing a locking mechanism being biased into a locked condition.

FIG. 7 is a cross sectional view taken along line 7-7 of FIG. 5 of an embodiment of the disclosure.

FIG. 8 is a left side view of an embodiment of the disclosure.

FIG. 9 is a perspective in-use view of an embodiment of the disclosure.

### DETAILED DESCRIPTION OF THE INVENTION

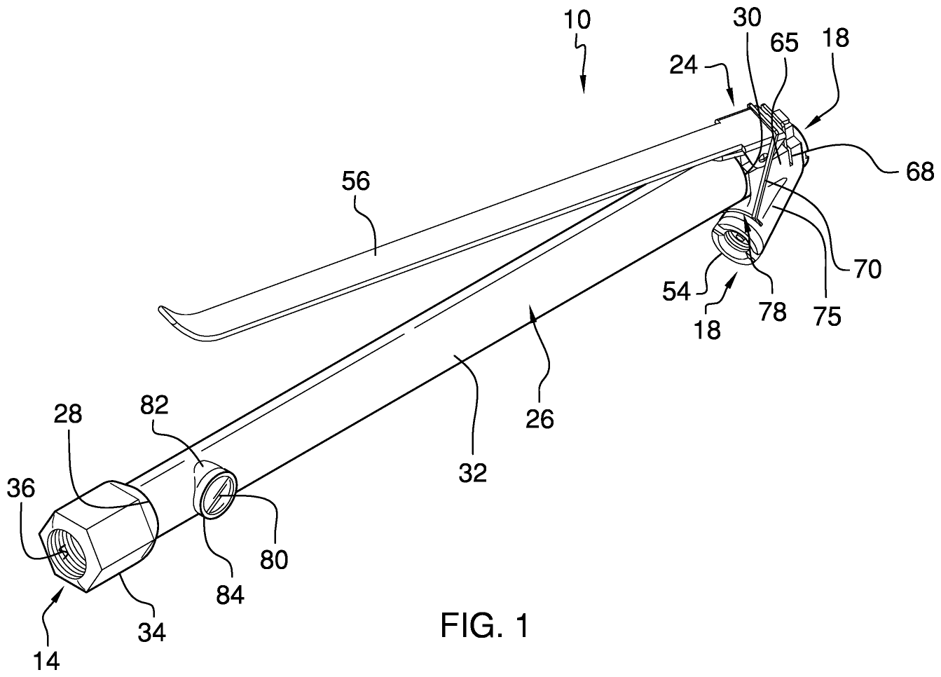

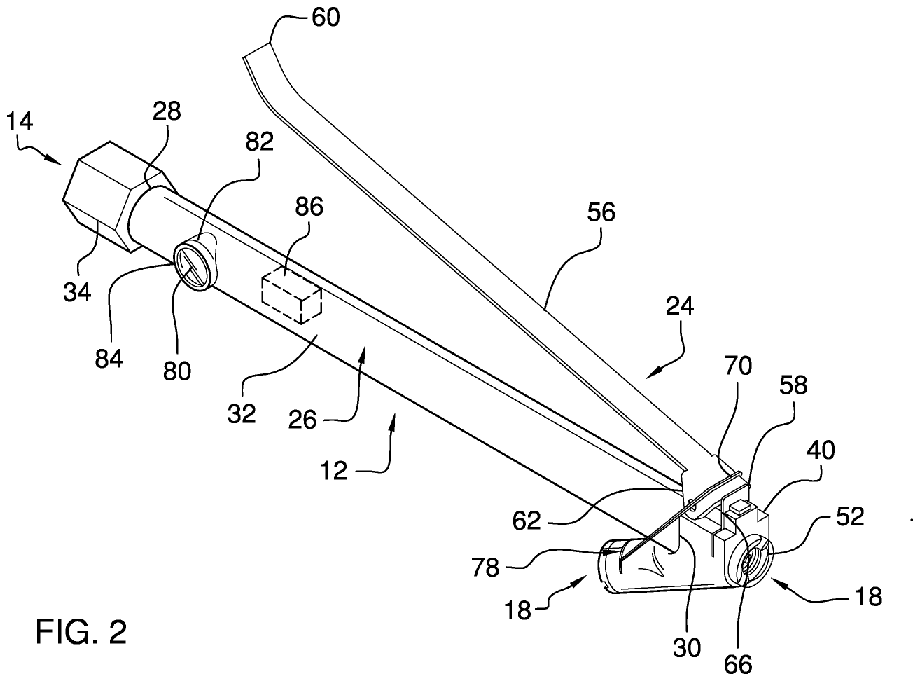

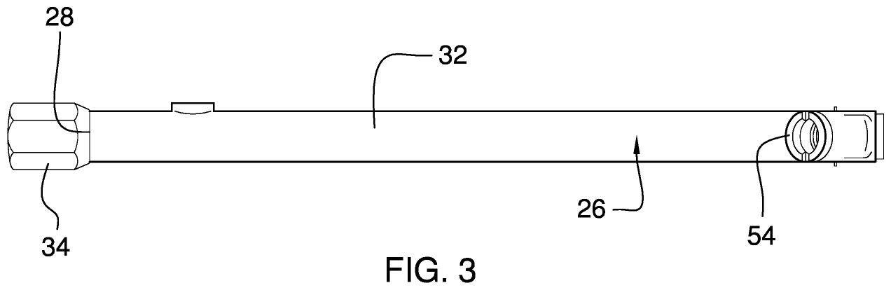

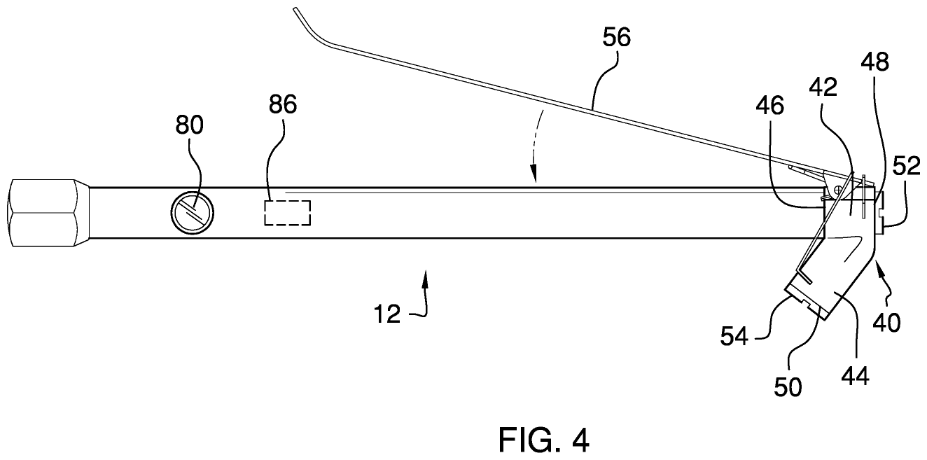

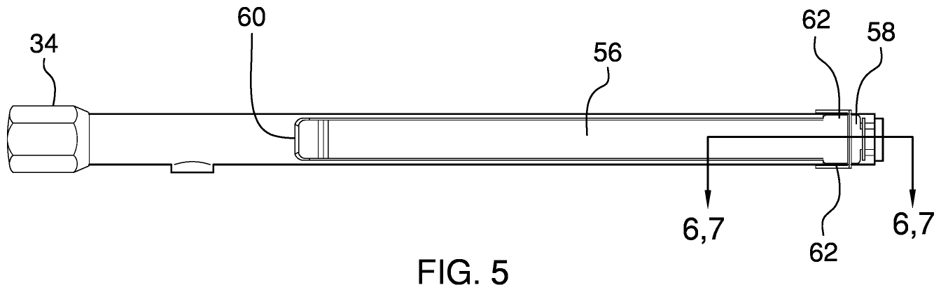

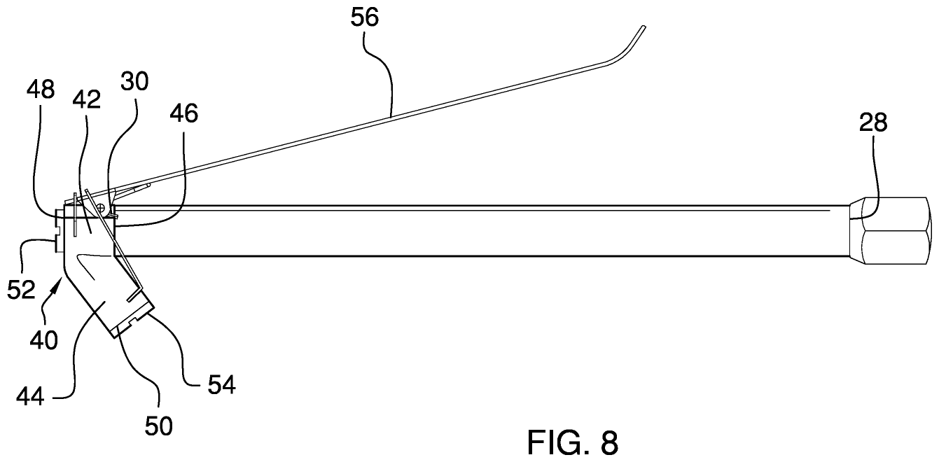

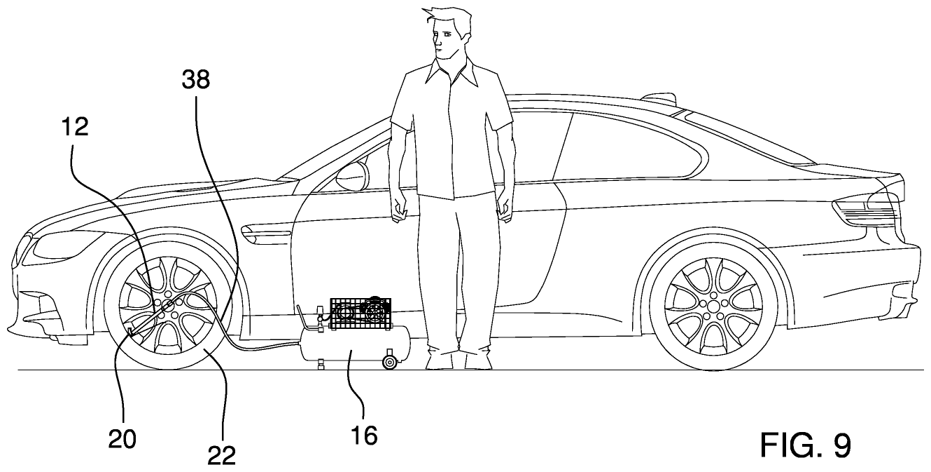

With reference now to the drawings, and in particular to FIGS. 1 through 9 thereof, a new inflation device embodying the principles and concepts of an embodiment of the disclosure and generally designated by the reference numeral 10 will be described.

As best illustrated in FIGS. 1 through 9, the tire inflation assembly 10 generally comprises an air chuck 12 that has an inlet 14 which can be fluidly attachable to a source of compressed air 16. The source of compressed air 16 may be an air compressor or other similar device commonly employed for inflating tires of vehicles. The air chuck 12 has a pair of outlets 18 and a respective one of the outlets 18 can be attached to a valve stem 20 of a tire 22 to direct compressed air into the tire 22 for inflating the tire 22. The tire 22 may be an inflatable tire of any conventional design that is commonly employed on motorized vehicles.

Each of the pair of outlets 18 is positioned on the air chuck 12 to have a direction of air flow which is oriented at a unique direction with respect to each other. In this way the air chuck 12 can be attached to the valve stem 20 at a variety of orientations to enhance employing the air chuck 12 to inflate the tire 22. The air chuck 12 includes a locking mechanism 24 that is movably integrated into the air chuck 12 and the locking mechanism 24 is in mechanical communication with each of the outlets 18. The locking mechanism 24 is biased into a locked condition to engage the valve stem 20 when the respective outlet is attached to the valve stem 20 for retaining the air chuck 12 on the valve stem 20. Conversely, the locking mechanism 24 is urgeable into an unlocked condition to disengage the valve stem 20 when the locking mechanism 24 is urged into the unlocked condition thereby facilitating the air chuck 12 to be removed from the valve stem 20.

The air chuck 12 comprises a tube 26 that has a first end 28, a second end 30 and an outer wall 32 extending between the first end 28 and the second end 30. A fitting 34 is rotatably coupled to the first end 28 and the fitting 34 has an interior surface 36 which is threaded to threadably engage a fitting 34 on an air hose 38 of the source of compressed air 16. The air chuck 12 includes a nozzle 40 which has a first arm 42 that is oriented at an angle with a second arm 44. The first arm 42 has a primary end 46 and a secondary end 48 and each of the primary end 46 and the secondary end 48 is open. The primary end 46 is attached to the second end 30 of the tube 26 such that the nozzle 40 is in fluid communication with the fitting 34 on the first end 28 of the tube 26 thereby facilitating the nozzle 40 to receive the compressed air.

The second arm 44 has a distal end 50 with respect to the first arm 42 and the second arm 44 is oriented at an angle with an axis extending between the first end 28 and the second end 30 of the tube 26. The distal end 50 is directed toward the first end 28 of the tube 26 and the distal end 50 is open. The nozzle 40 includes a first valve 52 disposed within the secondary end 48 of the first arm 42. The first valve 52 is biased into a closed condition to inhibit the compressed air from flowing outwardly through the first end 28. The first valve 52 is urgeable into an open condition to facilitate the compressed air to flow outwardly through the first end 28 when the valve stem 20 is inserted into the first end 28 for inflating the tire 22. The first valve 52 may comprise an air valve of any conventional design that is commonly employed with tire 22 inflation tools.

The nozzle 40 includes a second valve 54 that is disposed within the distal end 50 of the second arm 44. The second valve 54 is biased into a closed condition to inhibit the compressed air from flowing outwardly through the distal end 50. The second valve 54 is urgeable into an open condition to facilitate the compressed air to flow outwardly through the distal end 50 when the valve stem 20 is inserted into the distal end 50 for inflating the tire 22. The second valve 54 may comprise an air valve of any conventional design that is commonly employed with tire 22 inflation tools.

The locking mechanism 24 comprises a lever 56 that has a coupled end 58 and a free end 60 and the lever 56 has a pair of pivot points 62 each extending downwardly from the lever 56 at a point located adjacent to the coupled end 58. Each of the pivot points 62 is pivotally attached to an outer wall 32 of the first arm 42 of the nozzle 40 such that the lever 56 extends along the tube 26 toward the first end 28 of the tube 26. The lever curves upwardly at the free end 60 to enhance gripping the lever 56. The locking mechanism 24 includes a biasing member 64 that is positioned between the tube 26 and the lever 56 at a point located adjacent to the pair of pivot points 62 on the lever 56. The biasing member 64 biases the lever 56 to angle upwardly from the tube 26 having the second end 30 being directed downwardly toward the tube 26. The free end 60 of the lever 56 is urgeable downwardly toward the tube 26 having the second end 30 being lifted upwardly from the tube 26.

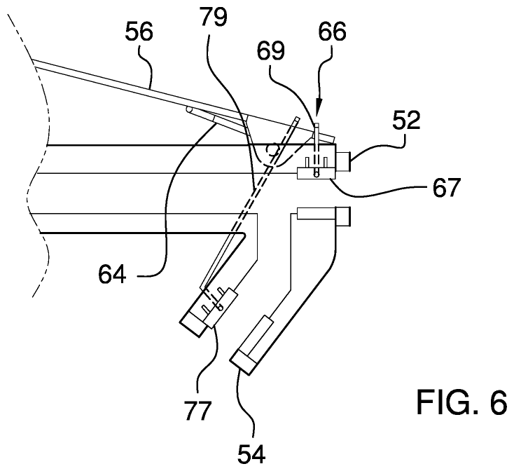

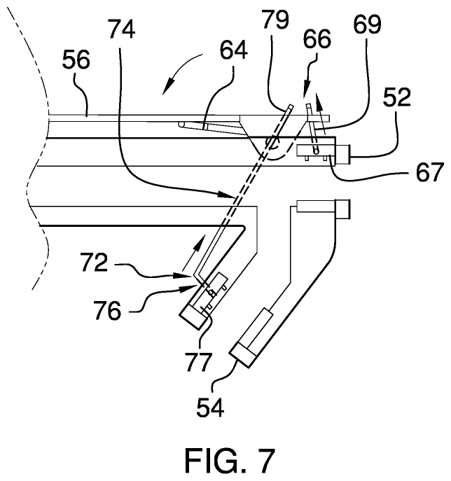

The locking mechanism 24 includes a first lock 66 that is attached to and extends downwardly from the lever 56 at a point located adjacent to the coupled end 58 of the lever 56. The first lock 66 extends through a first slot 68 in an outer wall 65 of the first arm 42 of the nozzle 40 when the lever 56 is biased to angle upwardly from the tube 26. In this way the first lock 66 can engage the valve stem 20 when the valve stem 20 is inserted into the first arm 42. The first lock 66 is urged to move outwardly from the first slot 68 when the free end 60 of the lever 56 is urged downwardly to release the valve stem 20 when the valve stem 20 is inserted into the first arm 42. As is most clearly shown in FIGS. 6 and 7, the first lock 66 includes a grip 67 slidably disposed in the first arm 42 and linkage 69 that extends through the first slot 68 and engages the lever 56.

The locking mechanism 24 includes a second lock 70 that is attached to and extends downwardly from the lever 56 at a point located adjacent to the first lock 66. The second lock 70. The second portion 76 of the second lock 70 extends through a second slot 78 in an outer wall 75 of the second arm 44 of the nozzle 40 when the lever 56 is biased to angle upwardly from the tube 26. In this way the second lock 70 can engage the valve stem 20 when the valve stem 20 is inserted into the second arm 44. The second lock 70 is urged to move outwardly from the second slot 78 when the free end 60 of the lever 56 is urged downwardly to release the valve stem 20 when the valve stem 20 is inserted into the second arm 44.

As is most clearly seen in FIGS. 6 and 7, the second lock 70 includes a grip 77 that is slidably disposed in the second arm 44 and a linkage 79 that extends through the second slot 78 and engages the lever 56. The linkage 79 associated with the second lock has a bend 72 that is distally positioned with respect to the lever 56 to define a first portion 74 of the second lock 70 forming an angle with a second portion 76 of the second lock 70. The second portion 76 of the linkage 79 extends through the second slot 78 and the first portion 74 of the linkage 79 engages the lever 56.

A pressure gauge 80 is integrated into the air chuck 12 such that the pressure gauge 80 is in fluid communication with the air chuck 12. In this way the pressure gauge 80 can display the air pressure in the tire 22 when either of the outlets 18 is attached to the valve stem 20. The pressure gauge 80 is integrated into the outer wall 32 of the tube 26 at a point located closer to the first end 28 of the tube 26 than the second end 30 of the tube 26. The tube 26 includes a housing 82 that extends outwardly from the outer wall 32 of the tube 26 and the housing 82 has a distal end 84 with respect to the outer wall 32 of the tube 26. The pressure gauge 80 is disposed in the distal end 84 of the housing 82 and the pressure gauge 80 may comprise a digital display, an analogue dial or any other type of pressure gauge that can visually indicate pressure. A pressure sensor 86 is disposed within the tube 26 to sense the air pressure within the tube 26 and the pressure sensor 86 is electrically coupled to the pressure gauge 80 thereby facilitating the pressure gauge 80 to indicate the air pressure within the tube 26. Furthermore, the pressure sensor 86 may comprise an electronic pressure sensor or the like.

In use, a respective one of the first arm 42 of the nozzle 40 or the second arm 44 of the nozzle 40 is positioned over the valve stem 20 of the tire 22, depending on which facilitates the air chuck 12 to be attached to the valve stem 20. The respective first valve 52 or second valve 54 is urged into the open position and the compressed air is released into the tire 22 to inflate the tire 22. The pressure gauge 80 displays the air pressure within the tire 22 to communicate how much air is needed to inflate the tire 22 to the manufacturer's recommendations. Furthermore, the respective first lock 66 or second lock 70 secures the air chuck 12 to the valve stem 20 thereby eliminating the need for a worker to hold the air chuck 12 while the tire 22 is being inflated. The lever 56 is depressed when the pressure gauge 80 indicates that the tire 22 has been inflated to the appropriate pressure to disengage the respective first lock 66 or second lock 70 from the valve stem 20 thereby facilitating the air chuck 12 to be removed from the valve stem 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tire inflation assembly being configured to releasably attach to a valve stem of a tire thereby facilitating the tire to be inflated, said assembly comprising:
an air chuck having an inlet being configured to be fluidly attachable to a source of compressed air, said air chuck having a pair of outlets wherein a respective one of said outlets is configured to be attached to a valve stem of a tire to direct compressed air into the tire for inflating the tire, each of said pair of outlets being positioned on said air chuck to have a direction of air flow which is oriented at a unique direction with respect to each other wherein said air chuck is configured to be attached to the valve stem at a variety of orientations to enhance employing said air chuck to inflate the tire, said air chuck including a locking mechanism being movably integrated into said air chuck, said locking mechanism being in mechanical communication with each of said outlets, said locking mechanism being biased into a locked condition wherein said locking mechanism is configured to engage the valve stem when said respective outlet is attached to the valve stem for retaining said air chuck on the valve stem, said locking mechanism being urgeable into an unlocked condition wherein said locking mechanism is configured to disengage the valve stem when said locking mechanism is urged into said unlocked condition thereby facilitating said air chuck to be removed from the valve stem; and
a pressure gauge being integrated into said air chuck such that said pressure gauge is in fluid communication with said air chuck wherein said pressure gauge is configured to display the air pressure in the tire when either of said outlets is attached to the valve stem.

2. The assembly according to claim 1, wherein said air chuck comprises:
a tube having a first end, a second end and an outer wall extending between said first end and said second end;
a fitting being rotatably coupled to said first end such that said fitting defines said inlet of said air chuck, said fitting having an interior surface being threaded wherein said interior surface is configured to threadably engage a fitting on an air hose of the source of compressed air; and
a nozzle having a first arm being oriented at an angle with a second arm, said first arm having a primary end and a secondary end, each of said primary end and said secondary end being open, said primary end being attached to said second end of said tube such that said nozzle defines said pair of outlets of said air chuck, said nozzle being in fluid communication with said fitting on said first end of said tube wherein said nozzle is configured to receive the compressed air, said second arm having a distal end with respect to said first arm, said second arm being oriented at an angle with an axis extending between said first end and said second end of said tube such that said distal end is directed toward said first end of said tube, said distal end being open.

3. The assembly according to claim 2, wherein said nozzle includes a first valve being disposed within said secondary end of said first arm, said first valve being biased into a closed condition wherein said first valve is configured to inhibit the compressed air from flowing outwardly through said first end, said first valve being urgeable into an open condition wherein said first valve is configured to facilitate the compressed air to flow outwardly through said first end when the valve stem is inserted into said first end for inflating the tire.

4. The assembly according to claim 3, wherein said nozzle includes a second valve being disposed within said distal end of said second arm, said second valve being biased into a closed condition wherein said second valve is configured to inhibit the compressed air from flowing outwardly through said distal end, said second valve being urgeable into an open condition wherein said second valve is configured to facilitate the compressed air to flow outwardly through said distal end when the valve stem is inserted into said distal end for inflating the tire.

5. The assembly according to claim 2, wherein said locking mechanism comprises:
a lever having a coupled end and a free end, said lever having a pair of pivot points each extending downwardly from said lever at a point located adjacent to said coupled end, each of said pivot points being pivotally attached to an outer wall of said first arm of said nozzle such that said lever extends along said tube toward said first end of said tube; and
a biasing member being positioned between said tube and said lever at a point located adjacent to said pair of pivot points on said lever, said biasing member biasing said lever to angle upwardly from said tube having said second end being directed downwardly toward said tube, said free end of said lever being urgeable downwardly toward said tube having said second end being lifted upwardly from said tube.

6. The assembly according to claim 5, wherein said locking mechanism includes a first lock being attached to and extending downwardly from said lever at a point located adjacent to said coupled end of said lever, said first lock extending through a first slot in said outer wall of said first arm of said nozzle when said lever is biased to angle upwardly from said tube wherein said first lock is configured to engage the valve stem when the valve stem is inserted into said first arm, said first lock being urged to move outwardly from said first slot when said free end of said lever is urged downwardly wherein said first lock is configured to release the valve stem when the valve stem is inserted into said first arm.

7. The assembly according to claim 6, wherein said locking mechanism includes a second lock being attached to and extending downwardly from said lever at a point located adjacent to said first lock, said second lock having a bend being distally positioned with respect to said lever to define a first portion of said second lock forming an angle with a second portion of said second lock, said second portion of said second lock extending through a second slot in an outer wall of said second arm of said nozzle when said lever is biased to angle upwardly from said tube wherein said second lock is configured to engage the valve stem when the valve stem is inserted into said second arm, said second lock being urged to move outwardly from said second slot when said free end of said lever is urged downwardly wherein said second lock is configured to release the valve stem when the valve stem is inserted into said second arm.

8. A tire inflation assembly being configured to releasably attach to a valve stem of a tire thereby facilitating the tire to be inflated, said assembly comprising:
an air chuck having an inlet being configured to be fluidly attachable to a source of compressed air, said air chuck having a pair of outlets wherein a respective one of said outlets is configured to be attached to a valve stem of a tire to direct compressed air into the tire for inflating the tire, each of said pair of outlets being positioned on said air chuck to have a direction of air flow which is oriented at a unique direction with respect to each other wherein said air chuck is configured to be attached to the valve stem at a variety of orientations to enhance employing said air chuck to inflate the tire, said air chuck including a locking mechanism being movably integrated into said air chuck, said locking mechanism being in mechanical communication with each of said outlets, said locking mechanism being biased into a locked condition wherein said locking mechanism is configured to engage the valve stem when said respective outlet is attached to the valve stem for retaining said air chuck on the valve stem, said locking mechanism being urgeable into an unlocked condition wherein said locking mechanism is configured to disengage the valve stem when said locking mechanism is urged into said unlocked condition thereby facilitating said air chuck to be removed from the valve stem, said air chuck comprising:
a tube having a first end, a second end and an outer wall extending between said first end and said second end;
a fitting being rotatably coupled to said first end such that said fitting defines said inlet of said air chuck, said fitting having an interior surface being threaded wherein said interior surface is configured to threadably engage a fitting on an air hose of the source of compressed air; and
a nozzle having a first arm being oriented at an angle with a second arm, said first arm having a primary end and a secondary end, each of said primary end and said secondary end being open, said primary end being attached to said second end of said tube such that said nozzle defines said pair of outlets of said air chuck, said nozzle being in fluid communication with said fitting on said first end of said tube wherein said nozzle is configured to receive the compressed air, said second arm having a distal end with respect to said first arm, said second arm being oriented at an angle with an axis extending between said first end and said second end of said tube such that said distal end is directed toward said first end of said tube, said distal end being open, said nozzle including a first valve being disposed within said secondary end of said first arm, said first valve being biased into a closed condition wherein said first valve is configured to inhibit the compressed air from flowing outwardly through said first end, said first valve being urgeable into an open condition wherein said first valve is configured to facilitate the compressed air to flow outwardly through said first end when the valve stem is inserted into said first end for inflating the tire, said nozzle including a second valve being disposed within said distal end of said second arm, said second valve being biased into a closed condition wherein said second valve is configured to inhibit the compressed air from flowing outwardly through said distal end, said second valve being urgeable into an open condition wherein said second valve is configured to facilitate the compressed air to flow outwardly through said distal end when the valve stem is inserted into said distal end for inflating the tire;
wherein said locking mechanism comprises:
a lever having a coupled end and a free end, said lever having a pair of pivot points each extending downwardly from said lever at a point located adjacent to said coupled end, each of said pivot points being pivotally attached to an outer wall of said first arm of said nozzle such that said lever extends along said tube toward said first end of said tube;
a biasing member being positioned between said tube and said lever at a point located adjacent to said pair of pivot points on said lever, said biasing member biasing said lever to angle upwardly from said tube having said second end being directed downwardly toward said tube, said free end of said lever being urgeable downwardly toward said tube having said second end being lifted upwardly from said tube;
a first lock being attached to and extending downwardly from said lever at a point located adjacent to said coupled end of said lever, said first lock extending through a first slot in said outer wall of said first arm of said nozzle when said lever is biased to angle upwardly from said tube wherein said first lock is configured to engage the valve stem when the valve stem is inserted into said first arm, said first lock being urged to move outwardly from said first slot when said free end of said lever is urged downwardly wherein said first lock is configured to release the valve stem when the valve stem is inserted into said first arm; and
a second lock being attached to and extending downwardly from said lever at a point located adjacent to said first lock, said second lock having a bend being distally positioned with respect to said lever to define a first portion of said second lock forming an angle with a second portion of said second lock, said second portion of said second lock extending through a second slot in an outer wall of said second arm of said nozzle when said lever is biased to angle upwardly from said tube wherein said second lock is configured to engage the valve stem when the valve stem is inserted into said second arm, said second lock being urged to move outwardly from said second slot when said free end of said lever is urged downwardly wherein said second lock is configured to release the valve stem when the valve stem is inserted into said second arm; and
a pressure gauge being integrated into said air chuck such that said pressure gauge is in fluid communication with said air chuck wherein said pressure gauge is configured to display the air pressure in the tire when either of said outlets is attached to the valve stem, said pressure gauge being integrated into said outer wall of said tube at a point located closer to said first end of said tube than said second end of said tube.
